(19) United States
(12) Patent Application Publication
(10) Pub. No.: US 2026/0127662 A1
(43) Pub. Date: May 7, 2026

(54) ARTIFICIAL INTELLIGENCE (AI) ENABLED BID ADJUDICATION SYSTEM USING GRAPH NEURAL NETWORKS

(71) Applicant: NORTHROP GRUMMAN SYSTEMS CORPORATION, Falls Church, VA (US)

(72) Inventors: Ivan D CACERES, Manor, TX (US); Ariane Jamie S. KRUMEL, San Diego, CA (US); Daniel Jackson BURSCH, Washington, DC (US); Gregory DEVOS, San Diego, CA (US)

(73) Assignee: NORTHROP GRUMMAN SYSTEMS CORPORATION, Falls Church, VA (US)

(21) Appl. No.: 18/936,038

(22) Filed: Nov. 4, 2024

(51) Int. Cl. G06Q 30/08

(52) U.S. Cl. CPC G06Q 30/08

(57) ABSTRACT

The artificial intelligence enabled bid adjudication system uses graph neural networks (GNNs) to infer/approximate courses of action (COAs). The COA winner decision process (WDP) is modeled as a bi-partite graph. A GNN model is trained using previously generated data (e.g., achieved from a previous brute force calculation). The trained GNN model is then used to solve the COA WDP. From the solution, the top n COAs and associate WDP solution scores are calculated. The top n inferred solution scores are then ranked to determine the solution of the COA WDP. The AI enabled bid adjudication system may be utilized with any battle management system (BMS) with a mathematical or heuristic COA scoring decision process.

### FIELD OF THE INVENTION

The present invention relates to performing bid adjudication using graph neural networks (GNN) to estimate the best solution to the auction using course of action (COA) calculations.

### BACKGROUND

Combinatorial auctions (CA) are efficient for determining resource allocation in different fields, such as in multi-domain mission managers or multi-domain battle mangers. First, single and two-bid combinations are evaluated before additional combinatorial analysis is performed using brute force methods or score improvement heuristic methods to calculate COA, where the COAs are the equivalents of bids in a CA. In some systems, an engagement adjudication engine (EAE) is utilized to determine the best COAs for given scenarios. Typically, when low number of factors are involved, brute forcing combinatoric calculations is feasible, but this practice quickly becomes intractable as the number of combinatorics increases, requiring other heuristic methods. The EAE evaluates all submitted bids as two-bid combinations and continues with higher-order combinations as long as score improvement continues (e.g., EAE checks for at least 0.01% score improvement or terminates combination analysis). Unfortunately, this combinatorial analysis process can be incredibly computational expensive as characterization experiments have demonstrated increasing number of potential COAs/bids evaluated by the EAE significantly increases time required for analysis.

While these methods are suitable for CAs with small numbers of bids (e.g., less than 50 bids), increasing the number of bids significantly increases the time required to determine the ideal solution to the winner determination problem. The problem of allocating items among the bidders to maximize the auctioneers' revenue is referred to as the winner determination problem (WDP), which is NP-complete to solve and inapproximable. For example, FIG. 1A depicts a graph showing the time required to reach a solution based on the number of bids using a brute force method for 50 bids. When the number of bids is ≤20, the time required is generally linear (but always exponential). However, as the number of bids increases, the time to reach a solution increases exponentially. This is especially true for larger number of bids. For example, while 50 bids takes ˜800 ms to compute a solution, 100 bids takes ˜9000 ms (FIG. 1B) to compute and 250 bids takes ˜225,000 ms (FIG. 1C) to compute. These computation times are generally not suitable for real world scenarios where decisions must be made much faster, especially for greater number of bids.

FIG. 2 depicts the time required to reach a solution based on a score improvement heuristic method. As depicted, the time to compute a solution is decreased with respect to the brute force method, but the time to research the solution exponentially increases as the number of bids are increased (e.g., ≥40 bids).

The time to determine the optimal or potential course of actions for many situations can be severely limited, such as during active engagement or deployment. Therefore, a need exists for alternative methods of calculating or approximating COAs for CAs which are more time efficient and scale-well with the number of bids (e.g., linearly or approximately linearly). The alternative methods should also be able to be trainable on small data sets since generating training data can be time-consuming, especially when there are large number or bids or items.

### SUMMARY

The AI enabled bid adjudication system of the present invention addresses these deficiencies by using graph neural networks (GNN) to infer/approximate COAs. The COA winner decision process (WDP) is modeled as a bi-partite graph. A GNN model is trained using previously generated data (e.g., achieved from a previous brute force calculation). The trained GNN model is then used to solve the COA WDP. From the solution, the top n COAs and associate WDP solution scores are calculated. The top n inferred solution scores are then ranked to determine the solution of the COA WDP. The AI enabled bid adjudication system may be utilized with any battle management system (BMS) with a mathematical or heuristic COA scoring decision process.

FIGS. 3 and 4 depict the time to solution (in ms) vs. the number of bids when the AI bid adjudication system of the present invention is utilized to solve the same CA from FIGS. 1 and 2. Specifically, the number of combined bids for the solution is set to 5 bids in FIG. 3 and 25 bids in FIG. 4. As shown, a 100× performance increase is quickly realized as the number of bids is increased. Further, the time scales linearly with the number of bids as opposed to exponentially in the other described methods. This means that much smaller training sets can be used when training the GNN model. A GNN model approach enables analysis of complex scenarios with many potential COAs that would be intractable by standard methods. An additional benefit is that GNN models can be trained using smaller data sets & still perform advanced inference by leveraging the relationship of the data/graph structure of the problem for larger data sets.

FIG. 5 depicts the time to solution vs. bids when (a) brute force methods are used, (b) score improvement heuristic methods are used, and (c) when the AI bid adjudication system of the present invention is used. Since the GNN is estimating/inferring the best combination of bids instead of calculating an exact answer (brute force method), it is generally orders of magnitude quicker and can be used feasibly for much larger numbers of bids/solutions required. Further, the GNN is also trained on similar scenarios, increasing its efficiency over any brute force method.

### BRIEF DESCRIPTION OF THE DRAWINGS

FIGS. 1A-1C depicts a graph showing the time required to reach a solution vs. number of bids using a brute force method.

FIG. 2 depicts a graph showing the time require to reach a solution vs. number of bids using a score improvement heuristic method.

FIG. 3 depicts a graph showing the time required to reach as solution vs. the number of bids using a method according to the present invention.

FIG. 4 depicts a graph showing the time required to reach a solution vs. the number of bids using a method according to an alternative embodiment of the invention.

FIG. 5 depicts a graph showing a comparison of the methods used in FIGS. 1A, 2, and 3.

FIG. 6 depicts a bipartite graph representation of a multi-unit WDP.

FIG. 7 depicts an example multi-domain battle manger that can be represented using a GNN.

FIGS. 8-10 show example bipartite graphs that can be used to model a multi-domain battle manager.

FIG. 11 depicts a system diagram for use with the AI enabled bid adjudication system.

FIG. 12 depicts a flowchart showing the steps utilized to construct a bipartite graph and determine a solution according to the AI enabled bid adjudication system.

FIG. 13 depicts a confusion matrix showing the accuracy of the predictions made using the GNN compared to a brute force method.

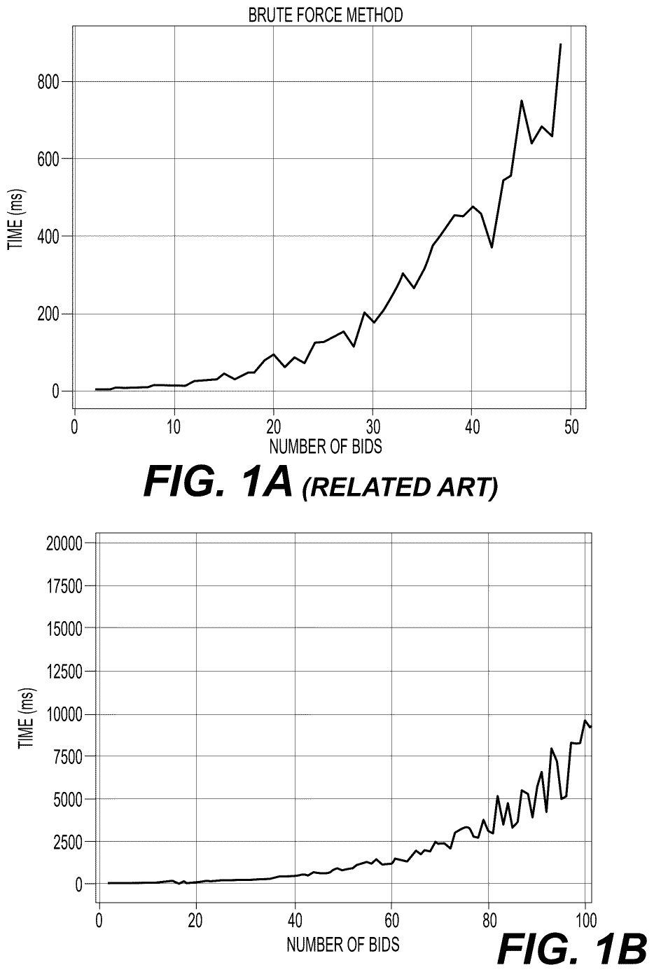

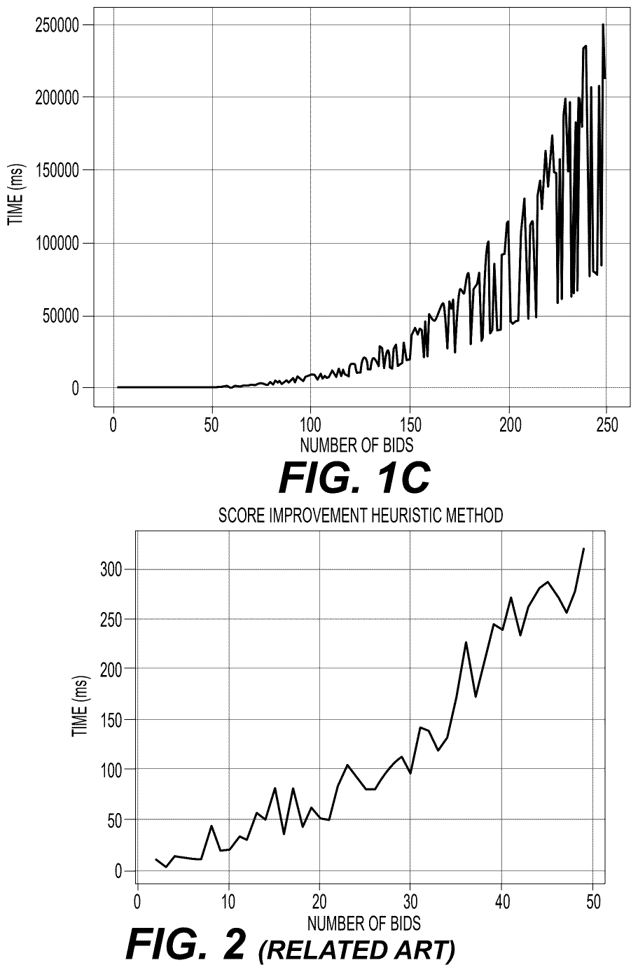

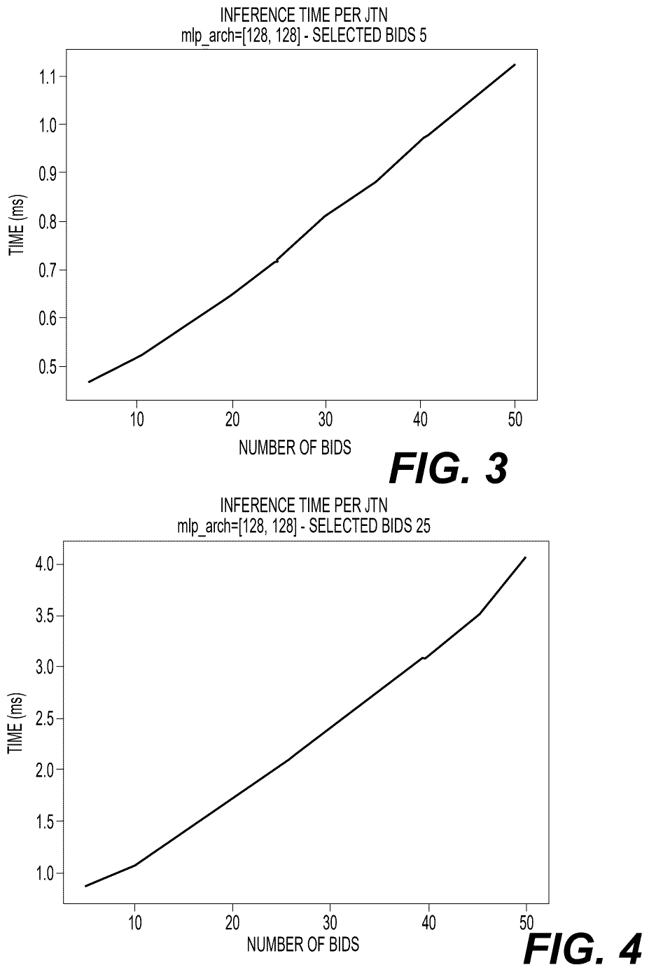

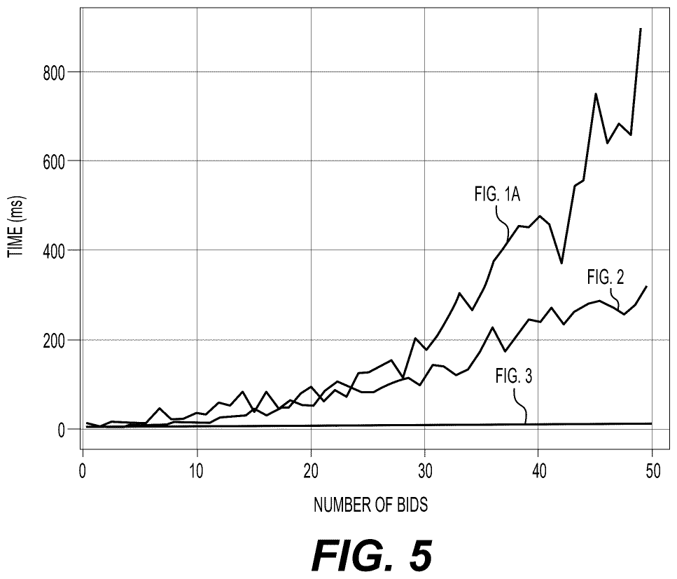

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The embodiments disclosed herein are for the purpose of providing a description of the present subject matter, and it is understood that the subject matter may be embodied in various other forms and combinations not shown in detail. Therefore, specific embodiments and features disclosed herein are not to be interpreted as limiting the subject matter as defined in the accompanying claims.

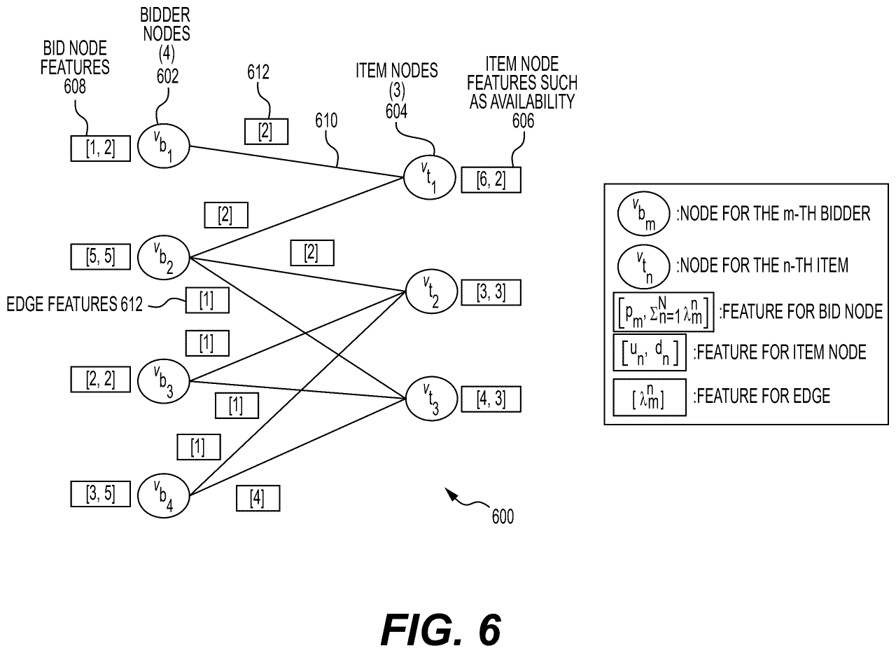

FIG. 6 depicts an example representation of a multi-WDP instance represented as a bipartite graph 600. Specifically, FIG. 6 depicts a bid-item graph 600 for a specific multi-unit WDP instance with M=4 bidders represented by bidder nodes 602 and with N=3 item nodes 604. The available units for each item node 604 are represented in item node features 606 and the bid price for each bidder is represented in bid node features 608. Each edge 610 comprises edge features 612. As depicted, the available units for each item node 604 are 6, 3, and 4, respectively.

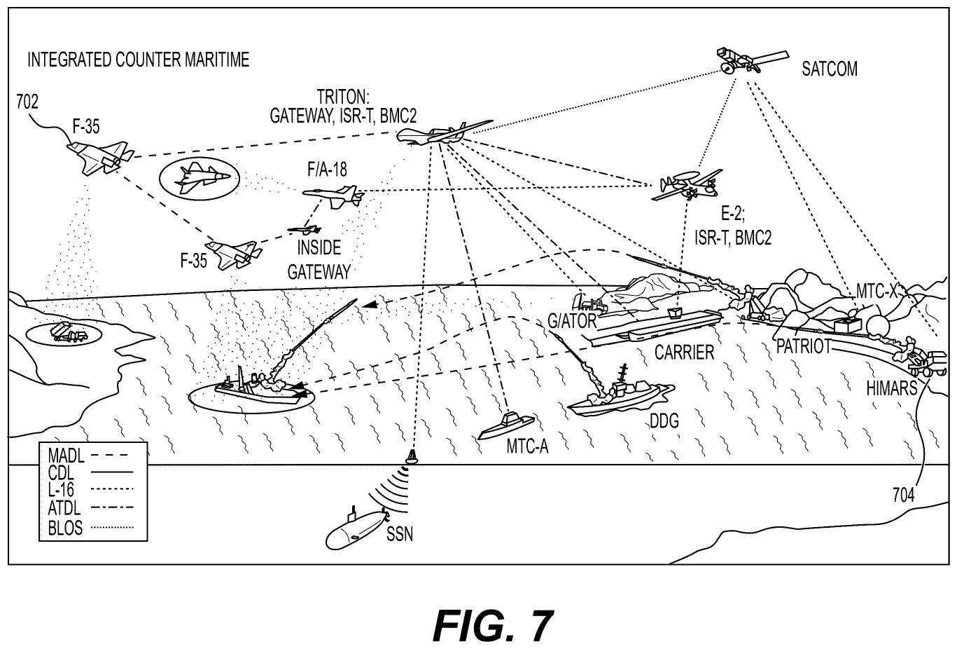

A bipartite graph can be used to represent the battle management simulator (or other similar scenarios) example depicted in FIG. 7. Various approaches can be taken to represent the “auction” depicted in FIG. 7. For example, the items can be grouped by mission, battle manager, or individual threat approach. The GNN can be structured in different ways to represent the problem, but the overall relationships between what is represented must be congruent between all samples. For example, an edge between node A & node B may have 8 attribute values representing various features. Well then, all edges represented in the graph must have 8 attribute values representing the same features.

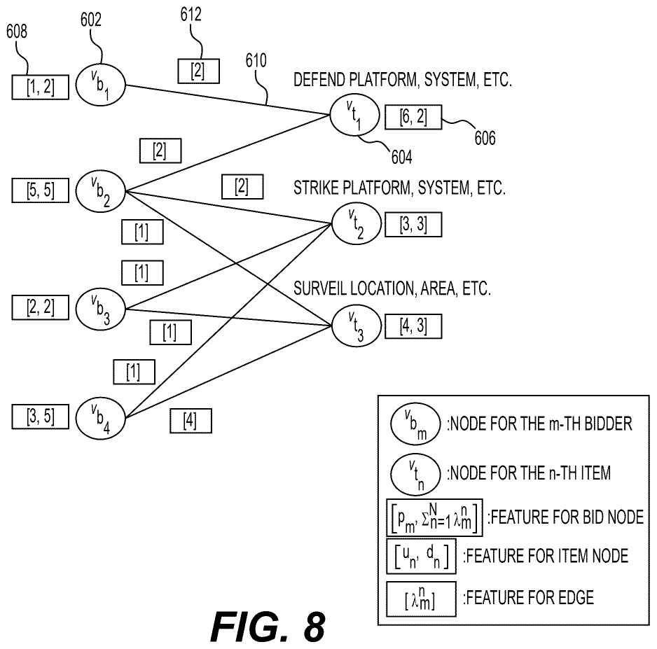

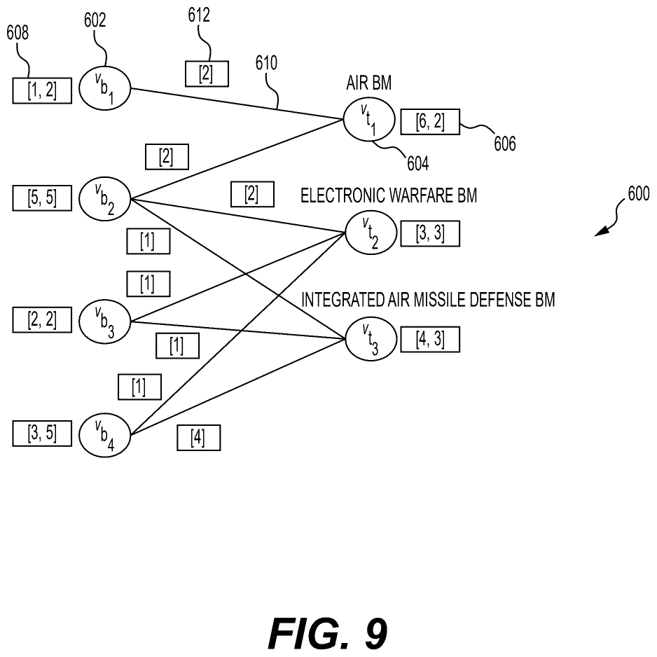

FIG. 8 depicts a bipartite graph in which items are grouped by mission. Here, the auctioneer is the battle manager scenario, the item nodes 604 are missions, the threats/targets are the number of units, and the bidder nodes 602 are battle managers. FIG. 9 depicts a bipartite graph in which items are grouped by battle manager. The auctioneer is the battle manager scenario, item nodes 604 are different battle managers, the missions are the number of units, and the bidder nodes 602 are battle managers.

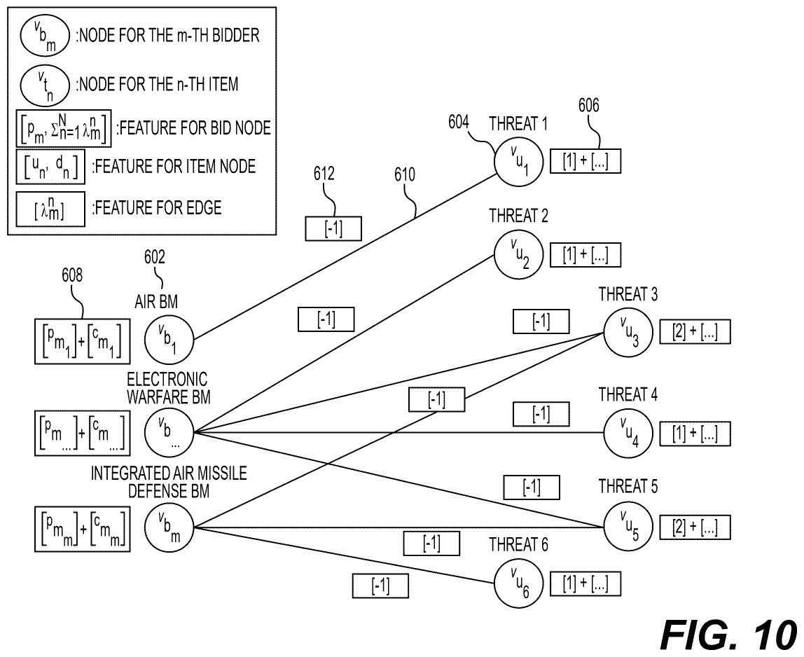

In some embodiments, the graphs can be broken up by bid group so that all bid-to-bid group edges 610 are equivalent as depicted in FIG. 10. The bidder nodes 604 are battle managers and the different threats are the item nodes 604.

Utilizing a bipartite graph 600 enables the prediction of structured behaviors via structured representation and computations. Also, using a bipartite graph 600 as the input also provides a bipartite graph as an output, with the resulting GNN being able to be used for the next iteration/decision that needs to be made. A GNN is also agnostic to graph topology (i.e., the number of nodes, edges, and global attributes). Open source software, such as the DeepMind Graph Nets Library, can be used to generate the bipartite graphs 600.

As previously stated, GNNs are useful for similar solving WDPs because they can be trained using smaller examples of larger problems. The topology of the GNN that you train on, informs, but is not required to be the same for graphs that the GNN model that is later used (e.g., for larger problems). The GNN model learns from the examples presented of the relationships between the data in that graph.

For example, a GNN model can be trained in a five red force vs. five blue force scenario where there may be 25 potential COAs to decide on how to neutralize three different threats. The resulting trained GNN model can then be to infer the best COA in a 100 blue force vs. 100 red force scenario with 10,000 potential COAs vs, 100 different threats, all without having to retrain the GNN model.

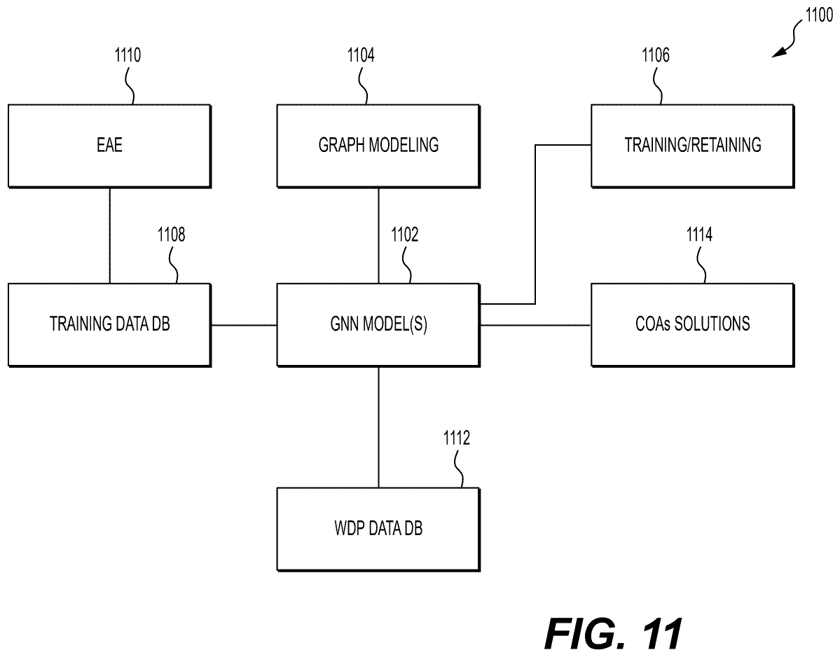

FIG. 11 depicts the primary components of the AI enabled bid adjudication system 1100 according to the present invention. As is known in the art, the various components or modules of AI enabled bid adjudication system 1100 can be implemented on any known server architecture or cloud computing platform. For example, the computations for GNN model 1102 may be implemented on one or more computers or servers having processors (CPUs) and other hardware such as graphics processing units (GPUs). Similarly, the data stored in training data database (DB) 1108 or WDP data DB 1112 can be stored locally or in the cloud. The processing requirements for AI enabled bid adjudication system 1100 generally determine the system architecture required (e.g., more bids requires more processing power).

Graph modeling module 1104 provides a user interface for creating and storing one or more GNN models 1102. As previously discussed, each GDP can be represented by a different GNN model 1102 as a bipartite graph (e.g., FIG. 8). Data for training GNN model 1102 can be generated by EAE 1110 (or equivalent system) and store in training data DB 1108. Training of GNN model 1102 (and retraining) is handled by training/retraining module 1106 utilizing the data stored in training data DB 1108. Regular auditing of the solutions 1114 produced by GNN model 1102 may be performed by training/retraining module 1106 to determine accuracy of the results. The data processed by GNN model 1102 is received from WDP data DB 1112 to generate solutions 1114 as previously discussed.

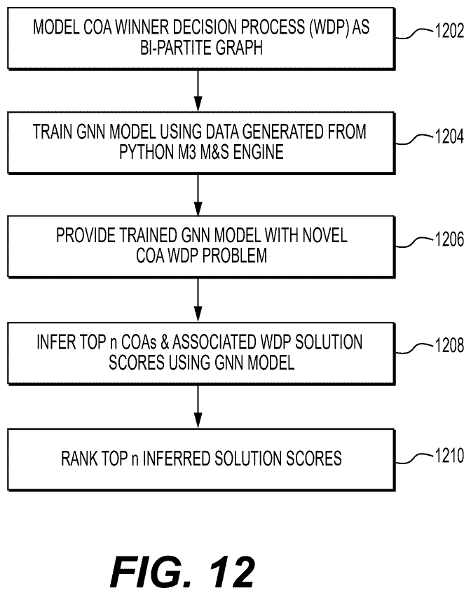

FIG. 12 depicts a flowchart showing the steps utilized to construct a bipartite graph and determine a solution according to the AI enabled bid adjudication system according to the present invention using the system diagram of FIG. 11. First, the multi-bid WDP instance to be solved is represented as a bipartite graph in step 1202. Examples of bipartite graphs have already been depicted and explained in FIGS. 6 and 8-10.

In order to solve the multi-bid WDP instance, a GNN model must be trained in step 1204. In a preferred embodiment, previously data generated using the brute force method (e.g., EAE) is utilized to train the GNN model. Variations of the input data can also be utilized to generate additional data for training as is known in the art. For example, data generated using a ME M&S search engine can be utilized for model training with a total of 2200 bid decisions evaluated. The data includes 450+ simulated scenarios (12 k+total bid decisions, ≤5 bids per decision). In a preferred embodiment, the training data is stored in a Python Pickle (.pkl) file. Evaluating 2 k+ bid decisions using the AI enabled bid adjudication system compared to ground truth demonstrated average Mean-Squared Error (MSE) of ˜0.07 per decision.

Because the AI enabled bid adjudication system scales approximately linearly with the number of bids, the GNN model can be trained with a small number of assets (e.g., on smaller data sets). Prior art estimation methods do not share this capability with GNNs and require model retraining as they are unable to evaluate conditions or situations which would require changing their input size from what they were originally trained with.

The trained GNN model can then be used with the bipartite graph representing the multi-bid WDP instance in step 1206. This step causes the COAs to be calculated for the bipartite graph. The top n COAs can be inferred from the WDP solution scores in step 1208. The n inferred solution scores can then be ranked to arrive at a solution in step 1210. Maximizing the “revenue” of the bipartite graphs is the same as maximizing the overall probability of success given all possible response options.

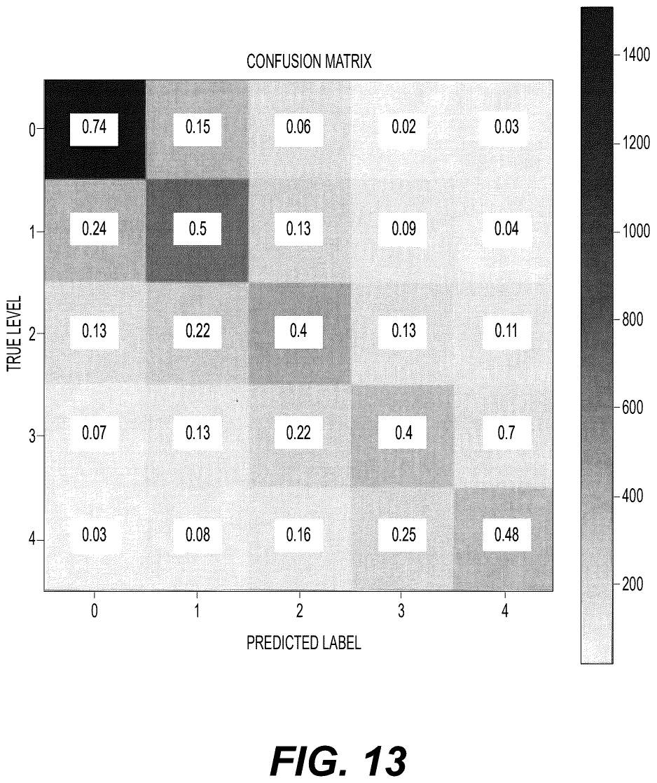

FIG. 13 depicts a confusion matrix showing the accuracy of the predictions made using the GNN method to the full combinatoric solution (EAE approach). The data for the confusion matrix of FIG. 13 was generated using 450+ simulated scenarios (12,000 total bid decisions, ≤5 bids per decision). 2200 bids were evaluated for accuracy. As depicted, there is a fairly strong correlation between the actual values and the predicted values from the GNN model.

Further, even if the AI enabled bid adjudication system of the present invention doesn't always predict the best or most accurate COA, the very fact that it can calculate a COA at all and respond timely is an advantage over prior art systems. For example, most brute force methods would not be able to calculate a COA in a fast-moving situation like in a missile defense. For example, if a COA is needed quickly to respond to decide on the best way to intercept incoming missiles, the AI enabled bid adjudication system of the present invention would be able to generate a number of COAs in the required time frame for response (e.g., 5 COAS) whereas a brute force system may not be able to calculate even a single COA in the same time period.

Also, as already discussed with reference to FIGS. 3-5, the AI enabled bid adjudication system of the present invention significantly reduces the time required for COA scoring, providing a solution that can effectively scale with mission resources.

While specific embodiments of the invention have been described above, it will be appreciated that the invention may be practiced other than as described. The embodiment(s) described, and references in the specification to “one embodiment,” “an embodiment,” “an example embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. A method of performing bid adjudication using graph neural networks (GNNs), the method comprising:
receiving a plurality of bids and associated parameters related to a winner determination problem in real time;
converting the received plurality of bids to a plurality bidder nodes and associated parameters to a plurality of associated bid node features;
estimating a plurality of courses of action (COAs) by inputting the plurality of bidder nodes and the plurality of associated bid node features using a GNN,
wherein the plurality of COAs are outputs of the GNN;
ranking a predetermined number of the plurality of COAs; and
selecting at least one COA from the predetermined number of COAs for execution; and
executing the at least one COA.

2. The method according to claim 1, wherein the GNN is trained on less inputs than the received plurality of bids.

3. The method according to claim 1, wherein the plurality of bidder nodes are arranged in a bipartite graph during the estimating.

4. The method according to claim 3, wherein edges of the bipartite graph are assigned the plurality of associated bid node features.

5. The method according to claim 1, wherein a plurality of the predetermined number of COAs are executed in addition to the at least one COA.

6. The method according to claim 1, wherein the GNN is trained on training data generated by an exact combinatorial solution.

7. The method according to claim 6, wherein the exact combinatorial solution utilizes a brute force method.

8. The method according to claim 1, further comprising:
comparing an accuracy of the plurality of COAs to a predetermined threshold at regular intervals; and
retraining the GNN if the accuracy falls below the predetermined threshold.

9. The method according to claim 1, wherein a timing to determine the plurality of COAs by the GNN is approximately linear with a number of bidder nodes.
